(19) United States
(12) Patent Application Publication
(10) Pub. No.: US 2026/0152677 A1
(43) Pub. Date: Jun. 4, 2026

(54) HOT MELT ADHESIVE COMPRISING SILOXIDE-FUNCTIONALIZED POLYOLEFINS

(71) Applicant: SABIC GLOBAL TECHNOLOGIES B.V., Bergen op Zoom (NL)

(72) Inventors: Lidia JASINSKA-WALC, Veldhoven (NL); Miloud BOUYAHYI, Eindhoven (NL); Robbert DUCHATEAU, Roostenlaan (NL); Jakub KRUSZYNSKI, Geleen (NL); Weronika NOWICKA, Sittard (NL)

(21) Appl. No.: 19/123,108

(22) PCT Filed: Oct. 16, 2023
(86) PCT No.: PCT/EP2023/078624

§ 371 Date: Apr. 22, 2025

(30) Foreign Application Priority Data
Oct. 24, 2022 (EP) 22203266.6

(51) Int. Cl. C08F 4/659; C08F 210/06; C08L 23/0807; C09J 7/35

(52) U.S. Cl. CPC C09J 123/28; C08F 8/42; C08F 2800/10; C08F 2810/50; C09J 2423/10

(57) ABSTRACT

Hot melt adhesive comprising a polar group-containing olefin copolymer having: number average molecular weight (Mₙ) between 10 to 50 kg/mol, crystallinity (X_{c}) content below 30%, enthalpy (ΔH) between 5 to 65 J/g, polydispersity index (Ð) from 2 to 6, melting temperature (Tₘ) between 4° and 120° C., and comprising at least 80 mol % of a constituent unit represented by the following formula (1), optionally a constituent unit represented by the following formula (2), and between 0.1 to 1 mol %, of a constituent unit represented by the following formula (3):

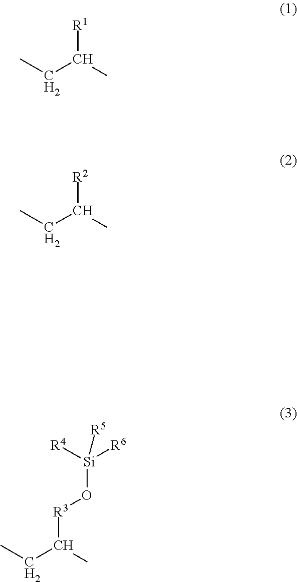

wherein: R¹ is H or CH₃; R² is selected from the list comprising: hydrocarbyl group having 0 to 10 carbon atoms, R³ is either selected from the list comprising: hydrocarbyl group having 2 to 10 carbon atoms, R⁴, R⁵, R⁶ can be identical or different and selected from the list comprising hydrogen, hydrocarbyl group having 0 to 10 carbon atoms.

### TECHNICAL FIELD OF THE INVENTION

The present invention relates to hot melt adhesive comprising siloxide-functionalized polyolefins.

### TECHNOLOGICAL BACKGROUND OF THE INVENTION

Hot Melt Adhesive (HMA) also known as hot glue is a thermoplastic adhesive resin that is solid at ambient temperature and can be molten to apply it on a surface. Most commonly, HMAs comprise EVA or polyolefin elastomers. Other examples are thermoplastic polyurethanes (TPU), styrene block copolymers (SBC), polyamides or polyesters.

The HMAs are produced in several forms, such as sticks, pellets, beads, granulates, pastilles, chips, slugs, flyers, pillows, blocks, films or spray and are used in various applications like packaging, hygiene products, furniture, footwear, textile & leather, electronics, book binding and graphics, building & construction, consumer DIY.

HMA provide several advantages over solvent-based adhesives. Volatile organic compounds are reduced or eliminated and drying or curing steps, typically required for 2 component adhesives, are eliminated. Furthermore, HMA typically have high mileage, low odor and are thermally stable. HMA have long shelf life and usually can be disposed of without special precautions. Furthermore, being a thermoplast, a HMA bond can be simply reversed by heating the substrate. The obvious drawback of this reversible bonding is the loss of bond strength at higher temperatures, up to complete melting of the adhesive. Hence, the use of HMA is limited to applications not exposed to elevated temperatures.

Polyolefin-based HMA's show good adhesion to low surface-energy materials such as untreated polyolefins or they can be applied to porous materials such as paper, carton or wood where the adhesion is obtained by physical inclusion of the HMA in the porous material. However, these polyolefin-based HMA's typically show low adhesive strength to polar materials such as metals, glass and polar polymeric materials.

EP1186619 discloses the use of polar functionalized monomer having more than 13 carbons C₁₃ in a polyolefin based HMA to improve the adhesion to polar substrates such as polycarbonates and aluminum.

However, HMA containing such functionalized monomer have a limited adhesive strengths.

It is an object of the present invention to provide a hot melt adhesive comprising a siloxide functionalized olefin copolymer having excellent adhesion properties to metals or polar and nonpolar resins.

There is a need for a new hot melt adhesive having at least one of the following binding properties:
Steel to steel with a Lap Shear Strength above 3 MPa
Aluminum to aluminum with a Lap Shear Strength above 3 MPa
Aluminum to polyolefin with a Lap Shear Strength above 1 MPa, preferably above 3 MPa,
Steel to polyolefin with a Lap Shear Strength above 3 MPa
Polyolefin to polyolefin with a Lap Shear Strength above 3 MPa

### SUMMARY

This object is achieved by the present invention, an hot melt adhesive comprising a polar group-containing olefin polymer having:
at least 80 mol % of a constituent unit represented by the following formula (1),
optionally a constituent unit represented by the following formula (2), and
between 0.1 to 1 mol %, preferably 0.1 to 0.5 mol %, of a constituent unit represented by the following formula (3):

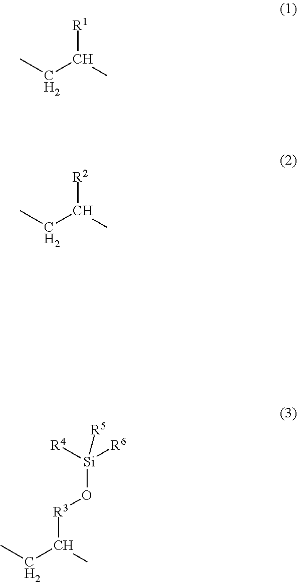

### Wherein:

R¹ is H or CH₃.
R² is selected from the list comprising: hydrocarbyl group having 0 to 10 carbon atoms, preferentially 1 to 6 and more preferentially 1 or 6 when R¹=H, and preferably 0, 2, 4 or 6 when R¹=CH₃,
R³ is either selected from the list comprising: hydrocarbyl group having 1 to 10 carbon atoms, preferentially 2 to 8, preferentially 4 to 8, more preferentially 4 or 6,
R⁴, R⁵, R⁶ can be identical or different and selected from the list comprising a hydrocarbyl group having 1 to 10 carbon atoms, preferentially 1 to 6 and more preferentially 1 to 4 carbon atoms or a combination of 1 and/or 3 and/or 4 carbon atoms.

In some embodiment, polar group-containing olefin polymer is having at least one of the followings, preferably two, more preferably four, more preferably three, more preferably all of the following
Number average molecular weight (Mn) between 5 to 50 kg/mol, preferably 10 to 50 kg/mol, preferably between 20 to 50 kg/mol, measured by the method described in the section “Size exclusion chromatography (SEC)” of the Measurement methods section of the present disclosure,
Crystallinity (X_{c}) content below 30%, preferably below 15%, more preferably below 10%, measured by the method described in the section “Differential scanning calorimetry (DSC)” of the Measurement methods section of the present disclosure,
Enthalpy (ΔH) between 5 to 65 J/g, preferably 5 to 30 J/g, measured by the method described in the section “Differential scanning calorimetry (DSC)” of the Measurement methods section of the present disclosure,
Polydispersity index (Ð) from 2 to 6, preferably between 3 to 6, more preferably between 4 to 6, measured by the method described in the section “Size exclusion chromatography (SEC)” of the Measurement methods section of the present disclosure,
Melting temperature (Tₘ) between 4° and 120° C., measured by the method described in the section “Differential scanning calorimetry (DSC)” of the Measurement methods section of the present disclosure.

In some embodiment, the constituent unit represented by the following formula (3) is the polymerization unit from one of the following monomers selected from the group comprising (allyloxy)trimethylsilane, (allyloxy)triethylsilane, (allyloxy)triisopropylsilane, tert-butyl(allyloxy)dimethylsilane, (allyloxy)dimethylphenylsilane, (but-3-en-1-yloxy)trimethylsilane, (but-3-en-1-yloxy)triethylsilane, (but-3-en-1-yloxy)triisopropylsilane, tert-butyl(but-3-en-1-yloxy)dimethylsilane, (but-3-en-1-yloxy)dimethylphenylsilane, (hex-5-en-1-yloxy)trimethylsilane, (hex-5-en-1-yloxy)triethylsilane, (hex-5-en-1-yloxy)triisopropylsilane, tert-butyl(hex-5-en-1-yloxy)dimethylsilane, (hex-5-en-1-yloxy)dimethylphenylsilane, trimethyl(undec-10-en-1-yloxy)silane, triethyl(undec-10-en-1-yloxy)silane, triisopropyl(undec-10-en-1-yloxy)silane, tert-butyldimethyl(undec-10-en-1-yloxy)silane, dimethylphenyl(undec-10-en-1-yloxy)silane, preferably (hex-5-en-1-yloxy)trimethylsilane, tert-butyl(hex-5-en-1-yloxy)dimethylsilane.

In some embodiment, the polymerization of the polar group-containing olefin polymer has been performed using a solution process.

In some embodiment, a siloxide-functionalized C₃ to C₁₂ monomer, preferably C₄ to C₁₀, preferably C₆ to C₁₀, preferably C₆ to C₈ olefin monomer has been used during the polymerization.

In some embodiment, the hot melt adhesive resin is produced by treatment of a corresponding hydroxyl-functionalized co- or terpolymer with a silylation agent, wherein the hydroxyl-functionalized co- or terpolymer has been previously produced by the solution polymerization of one or more olefin monomer and a hydroxyl-functionalized olefin monomer, which was prior protected with an aluminum trialkyl.

In some embodiment, the hot melt adhesive according to the invention is having at least one, preferably two, more preferably three, more preferably four, more preferably all of the following binding properties, which have been measured by the method described in the section “Lap Shear Strength” of the Measurement methods section wherein the measurements were performed with a Zwick type Z020 tensile tester equipped with a 10 kN load cell. Before measurements, samples were conditioned for 7 days at room temperature. The tests were performed on specimens (10 cm×2.5 cm) with surface overlapping 12.5 mm. A grip-to-grip separation of 140 mm was used. The samples were pre-stressed to 3 N, then loaded with a constant cross-head speed 100 mm·min⁻¹. To calculate the lap shear strength the reported force value divided by the bonding surface (25 mm×12.5 mm) of the specimens; the reported values are an average of at least 5 measurements of each composition:
Steel to steel with a Lap Shear Strength above 3 MPa, preferably above 4.5 MPa, more preferably above 5 MPa, even more preferably above 6 MPa,
Aluminum to aluminum with a Lap Shear Strength above 3 MPa, preferably above 4.5 MPa, more preferably above 5 MPa, even more preferably above 6 MPa,
Steel to polyolefin with a Lap Shear Strength above 3 MPa,
Aluminum to polyolefin with a Lap Shear Strength above 1 MPa, preferably above 2.5 MPa, more preferably 3 MPa,
Polyolefin to polyolefin with a Lap Shear Strength above 3 MPa.

In some embodiment, the hot melt adhesive according to the invention comprises:
a. Polymer part, between 16-100 wt %, preferably 30-50 wt % of the hot melt adhesive,
b. Tackifiers, between 0-70 wt %, preferably 20-40 wt %, of the hot melt adhesive,
c. Plasticizers, such as processing oils and waxes, between 0-40 wt %, preferably 10-40 wt % of the hot melt adhesive,
d. Filler, between 0-10 wt % of the hot melt adhesive,
e. Antioxidants, between 0-3 wt % of the hot melt adhesive,
f. Pigment, between 0-1 wt % of the hot melt adhesive,
   wherein the hot melt adhesive further comprise the polar group-containing olefin polymer according to the invention, and the polar group-containing olefin polymer is at least a part of the Polymer part, more preferably it is 100% of the Polymer part, the remaining part of the Polymer part, if present, is another polymer, preferably an olefin polymer.

Another aspect of the invention is a polar group-containing olefin polymer according to the following formula (4)

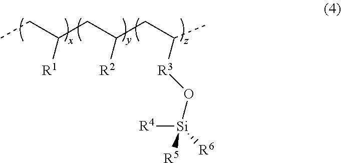

wherein
z is 0.1 to 1 mol %,
x is at least 80 mol %,
y is 0 or 100−(x+z) mol %,
R¹ is H or CH₃,
R² is selected from the list comprising: hydrocarbyl group having 0 to 10 carbon atoms, preferentially 1 to 6 and more preferentially 1 or 6 when R¹=H, and preferably 0, 2, 4 or 6 when R¹=CH₃,
R³ is a hydrocarbyl group having 1 to 10 carbon atoms, preferentially 2 to 8, preferentially 4 to 8, more preferentially 4 or 6,
R⁴, R⁵, R⁶ are identical or different and selected from the list comprising a hydrocarbyl group having 1 to 10 carbon atoms, preferentially 1 to 6 and more preferentially 1 to 4 carbon atoms or a combination of 1 and/or 3 and/or 4 carbon atoms.

In some embodiment, the polymerization of the polar group-containing olefin polymer has been performed using a solution process, with preferably a catalyst system comprising a the metal catalyst or catalyst precursor comprising a metal from Group 3-8, more preferably from Group 3-6 and/or wherein the metal catalyst comprises a metal selected from the group consisting of Ti, Zr, Hf, V, Cr, Fe, Co, Ni, Pd, preferably Zr or Hf, preferably a homogeneous single site catalyst, more preferably a hafnium complex of a polyvalent aryloxyether or a zirconium complex of a polyvalent aryloxyether.

In some embodiment, the polar group-containing olefin polymer according the preceding claim wherein it is having at least one of the followings, preferably two, more preferably three, more preferably four, more preferably all of the followings:
Number average molecular weight (Mn) between 5 to 50 kg/mol, preferably 10 to 50 kg/mol, preferably between 20 to 50 kg/mol, measured by the method described in the section “Size exclusion chromatography (SEC)” of the Measurement methods section of the present disclosure,
Crystallinity (X_{c}) content below 30%, preferably below 15%, more preferably below 10%, measured by the method described in the section “Differential scanning calorimetry (DSC)” of the Measurement methods section of the present disclosure,
Enthalpy (ΔH) between 5 to 65 J/g, preferably 5 to 30 J/g, measured by the method described in the section “Differential scanning calorimetry (DSC)” of the Measurement methods section of the present disclosure,
Polydispersity index (Ð) from 2 to 6, preferably between 3 to 6, more preferably between 4 to 6, measured by the method described in the section “Size exclusion chromatography (SEC)” of the Measurement methods section of the present disclosure,
Melting temperature (Tₘ) between 4° and 120° C., measured by the method described in the section “Differential scanning calorimetry (DSC)” of the Measurement methods section of the present disclosure.

Another aspect of the invention is the use of the polar group-containing olefin polymer according to the invention, for the fabrication of a hot melt adhesive, photovoltaic encapsulants, bitumen binders, surface modifiers for polyolefin preferably for automotive and household appliances and compatibilizer.

Another aspect of the invention is the use of the hot melt adhesive according to the invention, in order to glue together metals, glass, stone, wood, polar polymers or metals to glass, metals to stone, metals to wood, metal to polar polymers, glass to stone, glass to wood, glass to polar polymers, stone to wood, stone to polar polymers, wood to polar polymers, metals to polyolefins, glass to polyolefins, stone to polyolefins, wood to polyolefins or polar polymers to polyolefins, wherein stone are being as mineral material such as for example, granite, basalt, limestone, or artificial stone such as concrete or brick stone.

A final aspect of the invention is the use of hot melt adhesive according to the invention in order to glue together metals, glass, stone, wood, polar polymers or metals to glass, metals to stone, metals to wood, metal to polar polymers, glass to stone, glass to wood, glass to polar polymers, stone to wood, stone to polar polymers, wood to polar polymers, metals to polyolefins, glass to polyolefins, stone to polyolefins, wood to polyolefins or polar polymers to polyolefins, wherein stone are being as mineral material such as for example, granite, basalt, limestone, or artificial stone such as concrete or brick stone.

### DETAILED DESCRIPTION

The present invention preferably relates to a polyolefin-based hot melt adhesive resin a polar group-containing olefin polymer, preferably comprising siloxide functionalities as polar group.

According to the invention, the polyolefin-based hot melt adhesive resin is a copolymer of at least one first olefin monomer and a siloxide functionalized C₂ to C₁₂, preferably C₄ to C₁₂, more preferably C₄ to C₁₀ olefin monomer, and according to formula (4),

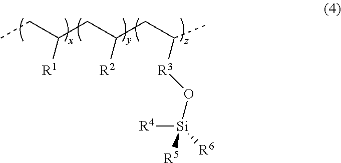

wherein
z is 0.1 to 1 mol %,
x is at least 80 mol %,
y is 0 or 100−(x+z) mol %,
R¹ is H or CH₃,
R² is selected from the list comprising: hydrocarbyl group having 0 to 10 carbon atoms, preferentially 1 to 6 and more preferentially 1 or 6 when R¹=H, and preferably 0, 2, 4 or 6 when R¹=CH₃,
R³ is a hydrocarbyl group having 1 to 10 carbon atoms, preferentially 2 to 8, preferentially 4 to 8, more preferentially 4 or 6,
R⁴, R⁵, R⁶ can be identical or different and selected from the list comprising a hydrocarbyl group having 1 to 10 carbon atoms, preferentially 1 to 6 and more preferentially 1 to 4 carbon atoms or a combination of 1 and/or 3 and/or 4 carbon atoms.

In some embodiment, polar group-containing olefin polymer is having at least one of the followings, preferably two, more preferably four, more preferably three, more preferably all of the following
Number average molecular weight (Mn) between 5 to 50 kg/mol, preferably 10 to 50 kg/mol, preferably between 20 to 50 kg/mol, measured by the method described in the section “Size exclusion chromatography (SEC)” of the Measurement methods section of the present disclosure,
Crystallinity (X_{c}) content below 30%, preferably below 15%, more preferably below 10%, measured by the method described in the section “Differential scanning calorimetry (DSC)” of the Measurement methods section of the present disclosure,
Enthalpy (ΔH) between 5 to 65 J/g, preferably 5 to 30 J/g, measured by the method described in the section “Differential scanning calorimetry (DSC)” of the Measurement methods section of the present disclosure,
Polydispersity index (Ð) from 2 to 6, preferably between 3 to 6, more preferably between 4 to 6, measured by the method described in the section “Size exclusion chromatography (SEC)” of the Measurement methods section of the present disclosure,
Melting temperature (Tₘ) between 4° and 120° C., measured by the method described in the section “Differential scanning calorimetry (DSC)” of the Measurement methods section of the present disclosure.

In some embodiment, the first olefin monomer is ethylene or propylene, preferably propylene.

In some embodiment, the hot melt adhesive resin according to the invention is a polyolefin-based copolymer, preferably a terpolymer resulting from the polymerization of a first olefin monomer, with optionally a second olefin monomer selected from the list comprising ethylene or C₃ to C₁₂ olefin monomer and a third—functionalized—olefin monomer, which is selected from the list comprising a siloxide functionalized C₃ to C₁₂, preferably C₄ to C₁₀ olefin monomer.

In some embodiment, when the first olefin monomer is ethylene, preferably the second olefin monomer is propylene, 1-butene, 1-hexene or 1-octene, more preferably propylene or 1-octene.

In some embodiment, when the first olefin monomer is propylene, preferably the second olefin monomer is ethylene, 1-butene, 1-hexene or 1-octene.

In some embodiment, the third monomer is a siloxide functionalized olefin monomer, preferably selected from the group comprising (allyloxy)trimethylsilane, (allyloxy)triethylsilane, (allyloxy)triisopropylsilane, tert-butyl(allyloxy)dimethylsilane, (allyloxy)dimethylphenylsilane, (but-3-en-1-yloxy)trimethylsilane, (but-3-en-1-yloxy)triethylsilane, (but-3-en-1-yloxy)triisopropylsilane, tert-butyl(but-3-en-1-yloxy)dimethylsilane, (but-3-en-1-yloxy)dimethylphenylsilane, (hex-5-en-1-yloxy)trimethylsilane, (hex-5-en-1-yloxy)triethylsilane, (hex-5-en-1-yloxy)triisopropylsilane, tert-butyl(hex-5-en-1-yloxy)dimethylsilane, (hex-5-en-1-yloxy)dimethylphenylsilane, trimethyl(undec-10-en-1-yloxy)silane, triethyl(undec-10-en-1-yloxy)silane, triisopropyl(undec-10-en-1-yloxy)silane, tert-butyldimethyl(undec-10-en-1-yloxy)silane, dimethylphenyl(undec-10-en-1-yloxy)silane, more preferably (hex-5-en-1-yloxy)trimethylsilane, tert-butyl(hex-5-en-1-yloxy)dimethylsilane preferably (hex-5-en-1-yloxy)trimethylsilane, (hex-5-en-1-yloxy)triethylsilane, (hex-5-en-1-yloxy)triisopropylsilane or tert-butyl(hex-5-en-1-yloxy)dimethylsilane, more preferably (hex-5-en-1-yloxy)trimethylsilane or tert-butyl(hex-5-en-1-yloxy)dimethylsilane.

In some embodiment, the hot melt adhesive resin is made in a solution process using a siloxide-functionalized C₃ to C₁₂ monomer, preferably C₄ to C₁₀, preferably C₆ to C₁₀, preferably C₆ to C₈ olefin monomer.

In some embodiment, the hot melt adhesive resin is produced by treatment of a corresponding hydroxyl-functionalized co- or terpolymer with a silylation agent, wherein the hydroxyl-functionalized co- or terpolymer has been previously produced by a polymerization of one or more olefin monomer and a hydroxyl-functionalized olefin monomer which was prior protected with an aluminum trialkyl, as describe in PCT/EP2021/082511.

The process embodiment using directly a siloxide-functionalized C₃ to C₁₂ monomer, is preferred as it does not require a purification step to remove the protection agent from the hydroxyl-functionality from the co- or terpolymer.

The tunable functionality of these functionalized olefin terpolymer HMA's makes them very suitable for gluing the same or different polar substrates such as metals, glass, stone, wood and polar polymers.

The general apolar nature of the functionalized olefin terpolymer HMA's furthermore provides excellent adhesion to low surface energy substrates such as polyolefins (i.e. HDPE, LDPE, LLDPE, PP), making these HMA's very suitable for gluing polyolefins to polyolefins, or for gluing polyolefins to polar substrates such as metals, glass, wood and polar polymers.

Hot melt adhesive comprising a polar group-containing olefin polymer which is having:
at least 80 mol % of a constituent unit represented by the following formula (1),
optionally a constituent unit represented by the following formula (2), and
between 0.1 to 1 mol %, preferably 0.1 to 0.5 mol %, of a constituent unit represented by the following formula (3):

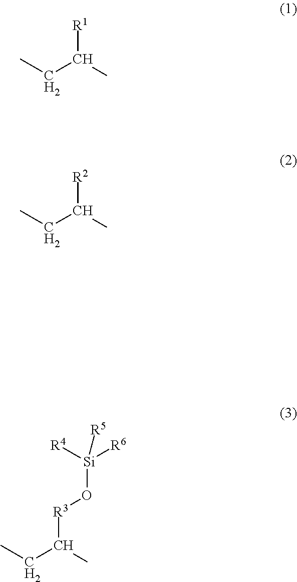

### Wherein:

R¹ is H or CH₃.
R² is selected from the list comprising: hydrocarbyl group having 0 to 10 carbon atoms, preferentially 1 to 6 and more preferentially 1 or 6 when R¹=H, and preferably 0, 2, 4 or 6 when R¹=CH₃,
R³ is either selected from the list comprising: hydrocarbyl group having 1 to 10 carbon atoms, preferentially 2 to 8, preferentially 4 to 8, more preferentially 4 or 6,
R4, R5, R6 can be identical or different and selected from the list comprising a hydrocarbyl group having 1 to 10 carbon atoms, preferentially 1 to 6 and more preferentially 1 to 4 carbon atoms or a combination of 1 and/or 3 and/or 4 carbon atoms.

The hot melt adhesive according to the invention comprises:
a. Polymer part, between 16-100 wt %, preferably 30-50 wt % of the hot melt adhesive,
b. Tackifiers, between 0-70 wt %, preferably 20-40 wt %, of the hot melt adhesive,
c. Plasticizers, such as processing oils and waxes, between 0-40 wt %, preferably 10-40 wt % of the hot melt adhesive,
d. Filler, between 0-10 wt % of the hot melt adhesive,
e. Antioxidants, between 0-3 wt % of the hot melt adhesive,
f. Pigment, between 0-1 wt % of the hot melt adhesive,
   wherein the hot melt adhesive further comprise the polar group-containing olefin polymer according to the invention, and the polar group-containing olefin polymer is at least a part of the Polymer part, more preferably it is 100% of the Polymer part, the remaining part of the Polymer part, if present, is another polymer, preferably an olefin polymer.

### Catalyst System Suitable for the Polymerization of Process Polar Group-Containing Olefin Polymer According to the Invention.

The process according to the invention is performed in the presence of a suitable catalyst system, which comprise at least:
A catalyst
A co-catalyst
Optionally a scavenger
Optionally a chain transfer agent

### Catalyst

The catalyst is a metal catalyst or catalyst precursor comprising a metal from Group 3-10, preferably from Group 3-8 of the IUPAC Periodic Table of elements and/or wherein the metal catalyst comprises a metal selected from the group consisting of Ti, Zr, Hf, V, Cr, Fe, Co, Ni, Pd, preferably Zr or Hf, preferably a homogeneous single site catalyst.

In some embodiment, the catalyst is a ligand-metal complex having a bridged bis-bi-aryl structure. In particular, the ligands are dianionic chelating ligands that can occupy up to four coordination sites of a metal precursor atom and more specifically have a bridged-bis-bi-aryl structure.

In some embodiment, the metal-ligand complexes used in this invention can be characterized by the general formula: (4,O)MLn′ (VI) where (4, O) is a dianionic ligand having at least 4 atoms that are oxygen and chelating to the metal M at 4 coordination sites through oxygen atoms with two of the bonds between the oxygen and the metal being covalent in nature and two of the bonds being dative in nature; M is a metal selected from the group consisting of group 4 of the Periodic Table of Elements, more specifically, from Hf or Zr, preferentially Hf; L is independently selected from the group consisting of halide (F, Cl, Br, I), optionally substituted alkyl, alkenyl, alkynyl, heteroalkyl, heteroalkenyl, heteroalkynyl, aryl, heteroaryl, alkoxyl, aryloxyl, silyl, boryl, phosphino, amino, alkylthio, arylthio, nitro, hydrido, borohydride, allyl, diene, phosphine, carboxylates, 1,3-dionates, oxalates, carbonates, nitrates, sulphates, ethers, thioethers and combinations thereof; and optionally two or more L groups may be linked together in a ring structure; n′ is 1, 2, 3, or 4.

In some embodiments, the metal-ligand complexes of this invention may be characterized by the general formula:

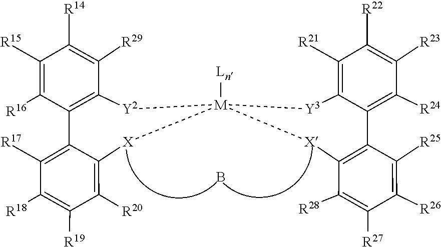

### Wherein

R¹⁴, R¹⁵, R¹⁶, R¹⁷, R¹⁸, R¹⁹, R²⁰, R²¹, R²², R²³, R²⁴, R²⁵, R²⁶, R²⁷, R²⁸ and R²⁹ are independently selected from the group consisting of hydride, halide, and optionally substituted hydrocarbyl, heteroatom-containing hydrocarbyl, alkoxy, aryloxy, silyl, boryl, phosphino, amino, alkylthio, arylthio, thioxy, seleno, nitro, and combinations thereof; optionally two or more R groups can combine together into ring structures, with such ring structures having from 3 to 100 atoms in the ring not counting hydrogen atoms
M is a metal Hf or Zr,
L is a moiety that forms a covalent, dative or ionic bond with M; and n′ is 1, 2, 3 or 4.
X, X′, Y² and Y³ are oxygen atoms,
B is a bridging group having from one to 50 atoms not counting hydrogen atoms, preferentially B is a propane bridge

In some preferred embodiments, the ligand-metal complex must be a hafnium or zirconium complex of a polyvalent aryloxyether, selected from the group comprising at least: bis((2-oxoyl-3-(1,2,3,4,6,7,8,9-octahydroanthracen-5-yl)-5-(methyl)phenyl)-2-phenoxy)-1,3-propanediylhafnium (IV) dimethyl, bis((2-oxoyl-3-(1,2,3,4,6,7,8,9-octahydroanthracen-5-yl)-5-(methyl)phenyl)-2-phenoxy)-1,3-propanediylhafnium (IV) dichloride, bis((2-oxoyl-3-(1,2,3,4,6,7,8,9-octahydroanthracen-5-yl)-5-(methyl)phenyl)-2-phenoxy)-1,3-propanediylhafnium (IV) dibenzyl, bis((2-oxoyl-3-(dibenzo-1H-pyrrole-1-yl)-5-(methyl)phenyl)-2-phenoxy)-1,3-propanediylhafnium (IV) dimethyl, bis((2-oxoyl-3-(dibenzo-1H-pyrrole-1-yl)-5-(methyl)phenyl)-2-phenoxy)-1,3-propanediylhafnium (IV) dichloride, bis((2-oxoyl-3-(dibenzo-1H-pyrrole-1-yl)-5-(methyl)phenyl)-2-phenoxy)-1,3-propanediylhafnium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dimethyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dichloride, bis((2-oxoyl-3-(1,2,3,4,6,7,8,9-octahydroanthracen-5-yl)-5-(methyl)phenyl)-2-phenoxymethyl)-1,4-butanediylhafnium (IV) dibenzyl, bis((2-oxoyl-3-(dibenzo-1H-pyrrole-1-yl)-5-(methyl)phenyl)-2-phenoxymethyl)-1,4-butanediylhafnium (IV)dimethyl, bis((2-oxoyl-3-(dibenzo-1H-pyrrole-1-yl)-5-(methyl)phenyl)-2-phenoxymethyl)-1,4-butanediylhafnium (IV) dichloride, bis((2-oxoyl-3-(dibenzo-1H-pyrrole-1-yl)-5-(methyl)phenyl)-2-phenoxymethyl)-1,4-butanediylhafnium (IV) dibenzyl, bis((2-oxoyl-3-(1,2,3,4,6,7,8,9-octahydroanthracen-5-yl)-5-(methyl)phenyl)-2-phenoxy)-2,4-pentanediylhafnium (IV) dimethyl, bis((2-oxoyl-3-(1,2,3,4,6,7,8,9-octahydroanthracen-5-yl)-5-(methyl)phenyl)-2-phenoxy)-2,4-pentanediylhafnium (IV) dichloride, bis((2-oxoyl-3-(1,2,3,4,6,7,8,9-octahydroanthracen-5-yl)-5-(methyl)phenyl)-2-phenoxy)-2,4-pentanediylhafnium (IV) dibenzyl, bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride, bis((2-oxoyl-3-(dibenzo-1H-pyrrole-1-yl)-5-(methyl)phenyl)-2-phenoxy)-2,4-pentanediylhafnium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)phenyl)-2-phenoxy)-1,3-propylhafnium (IV) dibenzyl, bis((2-oxoyl-3-(dibenzo-1H-pyrrole-1-yl)phenyl)-2-phenoxy)-1,4-n-butylhafnium (IV) dimethyl, bis((2-oxoyl-3-(dibenzo-1H-pyrrole-1-yl)phenyl)-2-phenoxy)-1,4-n-butylhafnium (IV) dibenzyl, bis((2-oxoyl-3-(3,6-bis(1,1-dimethylethyl)-9H-carbazolyl)phenyl)-2-phenoxy)-1,3-propylhafnium (IV) dimethyl, bis((2-oxoyl-3-(3,6-bis(1,1-dimethylethyl)-9H-carbazolyl)phenyl)-2-phenoxy)-1,3-propylhafnium (IV) dibenzyl, bis((2-oxoyl-3-(3,6-bis(1,1-dimethylethyl)-9H-carbazolyl)phenyl)-2-phenoxy)-1,4-n-butylhafnium (IV) dimethyl, bis((2-oxoyl-3-(3,6-bis(1,1-dimethylethyl)-9H-carbazolyl)phenyl)-2-phenoxy)-1,4-n-butylhafnium (IV) dibenzyl, bis((2-oxoyl-3-(4-methoxy-3,5-bis(1,1-dimethylethyl)phenyl)phenyl)-2-phenoxy)-1,4-n-butylhafnium (IV) dimethyl, bis((2-oxoyl-3-(4-methoxy-3,5-bis(1,1-dimethylethyl)phenyl)phenyl)-2-phenoxy)-1,4-n-butylhafnium (IV) dibenzyl, bis((2-oxoyl-3-(dibenzo-1H-pyrrole-1-yl)phenyl)-2-phenoxy)-1,2-ethylhafnium (IV) dimethyl, bis((2-oxoyl-3-(dibenzo-1H-pyrrole-1-yl)phenyl)-2-phenoxy)-1,2-ethylhafnium (IV) dibenzyl, bis((2-oxoyl-3-(dibenzo-1H-pyrrole-1-yl)phenyl)-2-phenoxy)-1,3-propylhafnium (IV) dimethyl; (OC-6-33)-[[2,2′″-[1,4-Butanediylbis(oxy-KO)]bis[3″,5′,5″-tris(1,1-dimethylethyl)[1,1′:3′,1″-terphenyl]-2′-olato-KO]](2-)]bis(phenylmethyl)hafnium; bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dimethyl, bis((2-oxoyl-3-(1,2,3,4,6,7,8,9-octahydroanthracen-5-yl)-5-(methyl)phenyl)-2-phenoxy)-1,3-propanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dibenzyl, bis((2-oxoyl-3-(dibenzo-1H-pyrrole-1-yl)-5-(methyl)phenyl)-2-phenoxy)-1,3-propanediylzirconium (IV) dimethyl, bis((2-oxoyl-3-(dibenzo-1H-pyrrole-1-yl)-5-(methyl)phenyl)-2-phenoxy)-1,3-propanediylzirconium (IV) dichloride, bis((2-oxoyl-3-(dibenzo-1H-pyrrole-1-yl)-5-(methyl)phenyl)-2-phenoxy)-1, 3-propanediylzirconium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dimethyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dichloride, bis((2-oxoyl-3-(1,2,3,4,6,7,8,9-octahydroanthracen-5-yl)-5-(methyl)phenyl)-2-phenoxymethyl)-1,4-butanediylzirconium (IV) dibenzyl, bis((2-oxoyl-3-(dibenzo-1H-pyrrole-1-yl)-5-(methyl)phenyl)-2-phenoxymethyl)-1,4-butanediylzirconium (IV)dimethyl, bis((2-oxoyl-3-(dibenzo-1H-pyrrole-1-yl)-5-(methyl)phenyl)-2-phenoxymethyl)-1,4-butanediylzirconium (IV) dichloride, bis((2-oxoyl-3-(dibenzo-1H-pyrrole-1-yl)-5-(methyl)phenyl)-2-phenoxymethyl)-1,4-butanediylzirconium (IV) dibenzyl, bis((2-oxoyl-3-(1,2,3,4,6,7,8,9-octahydroanthracen-5-yl)-5-(methyl)phenyl)-2-phenoxy)-2,4-pentanediylzirconium (IV) dimethyl, bis((2-oxoyl-3-(1,2,3,4,6,7,8,9-octahydroanthracen-5-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-2,4-pentanediylzirconium (IV) dibenzyl, bis((2-oxoyl-3-(dibenzo-1H-pyrrole-1-yl)-5-(methyl)phenyl)-2-phenoxy)-2,4-pentanediylzirconium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylzirconium (IV) dibenzyl, bis((2-oxoyl-3-(4-methoxy-3,5-bis(1,1-dimethylethyl)phenyl)phenyl)-2-phenoxy)-1,4-n-butylzirconium (IV) dimethyl, bis((2-oxoyl-3-(4-methoxy-3,5-bis(1,1-dimethylethyl)phenyl)phenyl)-2-phenoxy)-1,4-n-butylzirconium (IV) dibenzyl, bis((2-oxoyl-3-(dibenzo-1H-pyrrole-1-yl)phenyl)-2-phenoxy)-1,2-ethylzirconium (IV) dimethyl, bis((2-oxoyl-3-(dibenzo-1H-pyrrole-1-yl)phenyl)-2-phenoxy)-1,2-ethylzirconium (IV) dibenzyl, bis((2-oxoyl-3-(dibenzo-1H-pyrrole-1-yl)phenyl)-2-phenoxy)-1,3-propylzirconium (IV) dimethyl, bis((2-oxoyl-3-(dibenzo-1H-pyrrole-1-yl)phenyl)-2-phenoxy)-1,3-propylzirconium (IV) dibenzyl, bis((2-oxoyl-3-(dibenzo-1H-pyrrole-1-yl)phenyl)-2-phenoxy)-1,4-n-butylzirconium (IV) dimethyl, bis((2-oxoyl-3-(dibenzo-1H-pyrrole-1-yl)phenyl)-2-phenoxy)-1,4-n-butylzirconium (IV) dibenzyl, bis((2-oxoyl-3-(3,6-bis(1,1-dimethylethyl)-9H-carbazolyl)phenyl)-2-phenoxy)-1,3-propylzirconium (IV) dimethyl, bis((2-oxoyl-3-(3,6-bis(1,1-dimethylethyl)-9H-carbazolyl)phenyl)-2-phenoxy)-1,3-propylzirconium (IV) dibenzyl, bis((2-oxoyl-3-(3,6-bis(1,1-dimethylethyl)-9H-carbazolyl)phenyl)-2-phenoxy)-1,4-n-butylzirconium (IV) dimethyl, bis((2-oxoyl-3-(3,6-bis(1,1-dimethylethyl)-9H-carbazolyl)phenyl)-2-phenoxy)-1,4-n-butylzirconium (IV) dibenzyl; (OC-6-33)-[[2,2′″-[1,4-Butanediylbis(oxy-KO)]bis[3″,5′,5″-tris(1,1-dimethylethyl)[1,1′:3′,1″-terphenyl]-2′-olato-KO]](2-)]bis(phenylmethyl)zirconium, preferably bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride, bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride, bis((2-oxoyl-3-(dibenzo-1H-pyrrole-1-yl)-5-(methyl)phenyl)-2-phenoxy)-2,4-pentanediylhafnium (IV) dibenzyl, more preferably bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride, bis((2-oxoyl-3-(dibenzo-1H-pyrrole-1-yl)-5-(methyl)phenyl)-2-phenoxy)-2,4-pentanediylhafnium (IV) dibenzyl.

### Co-Catalyst

The co-catalyst is selected from the group: MAO, DMAO, MMAO, SMAO or ammonium salts or trityl salts of fluorinated tetraarylborates, preferably MAO, MMAO, trityl tetrakis(pentafluorophenyl)borate, dimethylanilinium or tri(alkyl)ammonium tetrakis (pentafluorophenyl)borate such as tri(n-butyl)ammonium tetrakis(pentafluorophenyl)borate, methyl di(alkyl)ammonium tetrakis(pentafluorophenyl)borate. More examples can be found in the review articles of Bochmann Organometallics 2010, 29, 4711-4740 and Chen and Marks Chem. Rev. 2000, 100, 1391-1434.

Methylaluminoxane or MAO as used in the present description may mean: a compound derived from the partial hydrolysis of trimethyl aluminum that serves as a co-catalyst for catalytic olefin polymerization.

Supported methylaluminoxane or SMAO as used in the present description may mean: a methylaluminoxane bound to a solid support.

Depleted methylaluminoxane or DMAO as used in the present description may mean: a methylaluminoxane from which the free trimethyl aluminum has been removed.

Modified methylaluminoxane or MMAO as used in the present description may mean: modified methylaluminoxane, viz. the product obtained after partial hydrolysis of trimethyl aluminum plus another trialkyl aluminum such as tri(isobutyl) aluminum or tri-n-octyl aluminum.

Fluorinated aryl borates as used in the present description may mean: a borate compound having four fluorinated (preferably perfluorinated) aryl ligands.

### Optional Scavenger

A scavenger can optionally be added to the catalyst system in order to react with impurities that are present in the polymerization reactor, and/or in the solvent and/or monomer feed. This scavenger prevents poisoning of the catalyst during the olefin polymerization process. The optional scavenger is selected from the group: trimethylaluminum, triethylaluminum, triisobutylaluminum, trihexylaluminum, trioctylaluminum, preferably triethylaluminum.

Surprisingly, triethylaluminum does not lead to severe chain transfer and does not inhibit the catalyst comprising the ligand-metal complex as describe above. This feature allows to use triethyl aluminum instead of triisobutylaluminum, which is a great cost benefit.

Optional Chain Transfer Agent Optional chain transfer agent is selected from the group: dihydrogen or AIR¹⁰₃, BR¹⁰₃ or ZnR¹⁰₂, where each R¹⁰ is independently selected from hydrogen or C1-C10 hydrocarbyl.

The use of such catalyst system, in combination with the ratio of commoners, as well as polymerization conditions, such as temperature and pressure, and/or the present of a chain transfer agent, will allow the skilled man in the art to tune the properties of the polymer to obtain the polar group-containing olefin polymer according to the invention in order to meet the requirement cited above:
Number average molecular weight (Mₙ),
Crystallinity (X_{c}),
Enthalpy (ΔH),
Polydispersity index (Ð),
Melting temperature (Tₘ),

### EXAMPLES

The following examples are not limiting examples and have been realized with the following monomers: ethylene (C₂), propylene (C₃), 1-hexene (C₆), 1-octene (C) and 5-hexen-1-ol (C₆OH). However, other monomer could be use in order to achieve the present invention.

Synthesis of propylene copolymer, poly(propylene-co-1-hexene) (poly(C₃-co-C₆)). The polymerization experiment was carried out using a stainless steel BÜCHI reactor (2 L) filled with pentamethylheptane (PMH) solvent (1 L) using a stirring speed of 600 rpm. Catalyst and comonomer solutions were prepared in a glove box under an inert dry nitrogen atmosphere. The reactor was first heated to 40° C. followed by the addition of TiBA (1.0 M solution in toluene, 2 mL) and 1-hexene (30 mL, 240 mmol). The reactor was charged at 40° C. with gaseous propylene (100 g, 2.38 mol) and the reactor was heated up to the desired polymerization temperature of 130° C. resulting in a partial propylene pressure of about 15 bar. Once the set temperature was reached, the polymerization reaction was initiated by the injection of the pre-activated catalyst precursor bis((2-oxoyl-3-(dibenzo-1H-pyrrole-1-yl)-5-(methyl)phenyl)-2-phenoxy)-2,4-pentane-diylhafnium (IV) dimethyl [CAS 958665-18-4](Hf-04, 1.5 μmol) in MAO (30 wt % solution in toluene, 11.2 mmol). The reaction was stopped by pouring the polymer solution into a container flask containing demineralized water/iPrOH (50 wt %, 1 L) and Irganox 1010 (1.0 M, 2 mmol). The resulting suspension was filtered and dried at 80° C. in a vacuum oven, prior the addition of Irganox 1010 as an antioxidant. The yield of poly(propylene-co-hexene) was 29.5 g (CEX1, Table 1).

Synthesis of hydroxyl-functionalized propylene terpolymer, poly(propylene-co-1-hexene-co-5-hexen-1-ol) (poly(C₃-co-C₆-co-C₆OH)). The polymerization experiment was carried out using a stainless steel BÜCHI reactor (2 L) filled with pentamethylheptane (PMH) solvent (1 L) using a stirring speed of 600 rpm. Catalyst and comonomer solutions were prepared in a glove box under an inert dry nitrogen atmosphere. The reactor was first heated to 40° C. followed by the addition of TiBA (1.0 M solution in toluene, 2 mL), 1-hexene (neat 10 mL, 80 mmol), and triethylaluminum (TEA)-pacified 5-hexen-1-ol (1.0 M solution in toluene, TEA:5-hexen-1-ol (mol ratio)=1, 10 mL, 10 mmol). The reactor was charged at 40° C. with gaseous propylene (100 g, 2.38 mol) and the reactor was heated up to the desired polymerization temperature of 130° C. resulting in a partial propylene pressure of about 15 bar. Once the set temperature was reached, the polymerization reaction was initiated by the injection of the pre-activated catalyst precursor bis((2-oxoyl-3-(dibenzo-1H-pyrrole-1-yl)-5-(methyl)phenyl)-2-phenoxy)-2,4-pentanediylhafnium (IV) dimethyl [CAS 958665-18-4](Hf-04, 2 μmol) in MAO (30 wt % solution in toluene, 11.2 mmol). The reaction was stopped by pouring the polymer solution into a container flask containing demineralized water/iPrOH (50 wt %, 1 L) and Irganox 1010 (1.0 M, 2 mmol). The resulting suspension was filtered and dried at 80° C. in a vacuum oven, prior the addition of Irganox 1010 as an antioxidant. Yield of poly(propylene-co-1-hexene-co-5-hexen-1-ol) was 25.6 g.

Purification protocol of hydroxyl-functionalized propylene terpolymer, poly(C₃-co-C₆-co-C₆OH). The copolymer obtained from the solution process may be purified in order to remove traces of aluminum residues. To do so, the copolymer (10 g) was dispersed in a mixture of dry toluene (400 mL) and concentrated (HCl, 37%, 10 mL) and heated under reflux. Once the polymer was properly dissolved, methanol (250 mL) was added to the hot mixture and the mixture was heated under stirring at 90-100° C. for an additional hour. Then the polymer was precipitated in cold methanol, filtered and washed 2× with methanol (CEX2, Table 2).

Siloxide-functionalization protocol to obtain poly(C₃-co-C₆-co-C₆OSiMe₃). The reaction was carried out under a nitrogen atmosphere using standard Schlenk techniques. Reagent grade commercial chemicals were used as received. Deashed and degassed poly(C₃-co-C₆-co-C₆OH) (0.5% mol OH; Mₙ=32.0 kg·mol⁻¹; 3.2-10⁻⁴ mol, 10.2 g) was dissolved in 300 mL of toluene at 60° C. The mixture was stirred until a transparent solution was obtained. Solutions of CISiMe₃ (274 mg, 2.5·10⁻³ mol) and NEt₃ (511 mg, 5.0·10⁻³ mol) were prepared in air- and moisture-free environment and transferred to the polymer solution via sealed rubber septum at 40° C. The reaction mixture was allowed to stir for approximately 10 minutes and then 4-dimethylaminopyridine (DMAP) (8.2 mg, 0.7·10⁻⁴ mol) was added. After this step, the solution became opaque and was left stirring at 40° C. overnight. Then the mixture was precipitated into cold methanol (yield 90%, EX1, Table 2).

Direct synthesis of siloxy-functionalized propylene terpolymer, poly(C₃-co-C₆-co-CeOSiMe₃). The terpolymerization experiment was carried out using a stainless steel BÜCHI reactor (20 L) filled with heptane solvent (10 L) using a stirring speed of 600 rpm. Catalyst and comonomer solutions were prepared in a glove box. For example, for EX2 (Table 2), the reactor was first heated to 40° C. followed by the addition of TiBA (1.0 M solution in toluene, 20 mL), neat 1-hexene (300 mL, 2.4 mol) and neat (hex-5-en-1-yloxy)trimethylsilane (34.5 g, 200 mmol). The reactor was loaded at 40° C. with gaseous propylene (1000 g) and was heated up to the desired polymerization temperature of 80° C. Once the set temperature was reached, the polymerization reaction was initiated by the injection of the pre-activated catalyst rac-Me₂Si(2-Me-4-Ph-Ind)₂ZrCl₂ (9 mg, 15 μmol) in MAO (30 wt % solution in toluene, 45 mmol). The reaction was stopped by pouring the polymer solution into a 20 L stainless steel vessel containing acidified isopropanol (2.5% v/v HCl, 3 L) and Irganox 1010 (1.0 M, 5 mmol). The resulting suspension was stirred for 4 h, filtered, washed with demineralized water/iPrOH (50 wt %, 2×2 L) and dried at 80° C. in a vacuum oven, prior the addition of Irganox 1010 as antioxidant.

Direct synthesis of siloxy-functionalized propylene terpolymer, poly(C₃-co-C₆-co-CeOSiMe₂tBu). The same terpolymerization procedure as described for the synthesis of poly(C3-co-C6-co-C6OSiMe₃) was applied to produce poly(C₃-co-C₆-co-C₆OSiMe₂tBu) (EX3, Table 2) and poly(C₃-co-C₃-co-C₆OSiMe₂tBu) (EX4, Table 2) using rac-Me₂Si(2-Me-4-Ph-Ind)₂ZrCl₂ (6 mg, 10 μmol), which was injected after the injection of TiBA scavenger (1.0 M solution in toluene, 20 mL), neat 1-hexene (300 mL, 2.4 mol) or neat 1-octene (200 mL, 1.3 mol), and neat tert-butyl(hex-5-en-1-yloxy)dimethylsilane (42.9 g, 200 mmol).

Direct synthesis of siloxy-functionalized propylene terpolymer, poly(C₃-co-C₂-co-CeOSiMe₂tBu). The terpolymerization experiment was carried out in a stainless steel BÜCHI reactor (2 L) filled with heptane solvent (1 L) using a stirring speed of 600 rpm. Catalyst and comonomer solutions were prepared in a glove box. For EX5 (Table 2), the reactor was first heated to 40° C. followed by the addition of TiBA (1.0 M solution in toluene, 2 mL) and neat tert-butyl(hex-5-en-1-yloxy)dimethylsilane (4.3 g, 20 mmol). The reactor was saturated at 40° C. with gaseous propylene/ethylene mixture (weight ratio=90/10) and was heated up to the desired polymerization temperature of 80° C. resulting in a total pressure of 9 bar. Once the set temperature was reached, the reaction was initiated by the injection of the pre-activated catalyst precursor rac-Me₂Si(2-Me-4-Ph-Ind)₂ZrCl₂ (0.7 mg, 1 μmol) in MAO (30 wt % solution in toluene, 4.5 mmol). The pressure was kept constant at 9 bar with continuous feed of gaseous propylene/ethylene mixture (weight ratio=90/10). The reaction was stopped by pouring the polymer solution into an Erlenmeyer flask containing acidified isopropanol (2.5% v/v HCl, 500 mL) and Irganox 1010 (1.0 M, 0.5 mmol). The resulting suspension was stirred for 4 h, filtered, washed with demineralized water/iPrOH (50 wt %, 2×500 mL) and dried at 80° C. in a vacuum oven, prior the addition of Irganox 1010 as antioxidant.

TABLE 1
Characteristics of the comparative poly(C₃-co-C₆)
and poly(C₃-co-C₆-co-C₆OH) polymers produced
according to the abovementioned protocols.

| | | | | Mₙ | | | ΔH |
|---|---|---|---|---|---|---|---|
| | | | X_{c} | kg · | | Tₘ | J · |
| EX | Composition | C₃:C_{6:}C₆OH | % | mol⁻¹ | Ð | ° C. | g⁻¹ |
| CEX1 | poly(C₃-co-C₆) | 91.9:8.1:0 | 12.3 | 25.7 | 3.1 | 85.9 | 25.5 |

*mol % with a standard deviation = 0.1 mol %

TABLE 2
Characteristics of copolymer and terpolymers according to the invention with
different composition produced according to the abovementioned protocols.

| | | (1):(2):(3) | X_{c} | Mₙ | | Tₘ | ΔH |
|---|---|---|---|---|---|---|---|
| EX | Composition | (mol %)* | % | kg · mol⁻¹ | Ð | ° C. | J · g⁻¹ |
| EX1 | poly(C₃-co-C₆-co-C₆OSiMe₃) | 90.4:9.1:0.5: | 11.1 | 36.1 | 4.4 | 82.1 | 21.4 |
| EX2 | poly(C₃-co-C₆-co-C₆OSiMe₃) | 92.6:7:0.4 | 12.0 | 44.3 | 4.4 | 88 | 24.8 |
| EX3 | poly(C₃-co-C₆-co-C₆OSiMe₂tBu) | 90.8:8.9:0.3 | 10.8 | 37.2 | 4.1 | 83 | 22.4 |
| EX4 | poly(C₃-co-C₈-co-C₆OSiMe₂tBu) | 93.6:6:0.4 | 13.2 | 39.3 | 4.3 | 79 | 27.3 |
| EX5 | poly(C₃-co-C₂-co-C₆OSiMe₂tBu) | 82.5:17:0.5 | 1.0 | 51.2 | 4.5 | 89 | 2.0 |

*mol % with a standard deviation = 0.1 mol %

TABLE 3
Lap shear test results of terpolymers with different composition
produced according to the abovementioned protocols.

| | Lap Shear Strength [MPa] | | | | |
|---|---|---|---|---|---|
| | STEEL/ | ALUMINUM/ | STEEL/ | ALUMI- | |
| EX | PP | ALUMINUM | STEEL | NUM/PP | PP/PP |
| EX1 | 3.3 ± 0.9 | 7.2 ± 0.3 | 6.8 ± 0.2 | 2.8 ± 0.2 | 3.8 ± 0.5 |
| EX2 | 3.2 ± 0.7 | 6.7 ± 0.5 | 6.6 ± 0.3 | 3.1 ± 0.5 | 4.1 ± 0.2 |
| EX3 | 3.1 ± 0.5 | 6.9 ± 0.4 | 6.2 ± 0.5 | 1.2 ± 0.3 | 3.0 ± 0.5 |
| EX4 | 3.0 ± 0.8 | 6.2 ± 0.8 | 5.7 ± 0.7 | 1.0 ± 0.3 | 3.1 ± 0.6 |
| EX5 | 3.0 ± 0.3 | 5.0 ± 0.4 | 4.6 ± 0.8 | 1.1 ± 0.4 | 3.1 ± 0.6 |
| CEX1 | 0.5 ± 0.3 | 0.8 ± 0.3 | 2.7 ± 0.5 | 0.4 ± 0.2 | 5.1 ± 0.3 |

The hot melt adhesive according to the invention is having at least one, preferably two, more preferably three, more preferably four, more preferably all of the following binding properties, which have been measured by the method described in the section “Lap Shear Strength” of the Measurement methods section wherein the measurements were performed with a Zwick type Z020 tensile tester equipped with a 10 kN load cell. Before measurements, samples were conditioned for 7 days at room temperature. The tests were performed on specimens (10 cm×2.5 cm) with surface overlapping 12.5 mm. A grip-to-grip separation of 140 mm was used. The samples were pre-stressed to 3 N, then loaded with a constant cross-head speed 100 mm·min⁻¹.

To calculate the lap shear strength the reported force value divided by the bonding surface (25 mm×12.5 mm) of the specimens; the reported values are an average of at least 5 measurements of each composition:
Steel to steel with a Lap Shear Strength above 3 MPa, preferably above 4.5 MPa, more preferably above 5 MPa, even more preferably above 6 MPa,
Aluminum to aluminum with a Lap Shear Strength above 3 MPa, preferably above 4.5 MPa, more preferably above 5 MPa, even more preferably above 6 MPa,
Steel to polyolefin with a Lap Shear Strength above 3 MPa,
Aluminum to polyolefin with a Lap Shear Strength above 1 MPa, preferably above 2.5 MPa, more preferably 3 MPa,
Polyolefin to polyolefin with a Lap Shear Strength above 3 MPa.

### Measurements.

### Size Exclusion Chromatography (SEC).

SEC measurements were performed at 150° C. on a Polymer Char GPC-IR® built around an Agilent GC oven model 7890, equipped with an auto-sampler and the Integrated Detector IR4. 1, 2-Dichlorobenzene (o-DCB) was used as an eluent at a flow rate of 1 mL/min. The data were processed using Calculations Software GPC One®. The molecular weights (Mₙ, M_{w}) and polydispersities (Ð) were calculated with respect to polyethylene or polystyrene standards.

### Liquid-State ¹H NMR.

¹H NMR and 13C NMR spectra were recorded at room temperature or at 80° C. using a Varian Mercury Vx spectrometer operating at Larmor frequencies of 400 MHz and 100.62 MHz for ¹H and ¹³C, respectively. For ¹H NMR experiments, the spectral width was 6402.0 Hz, acquisition time 1.998 s and the number of recorded scans equal to 64. ¹³C NMR spectra were recorded with a spectral width of 24154.6 Hz, an acquisition time of 1.3 s, and 256 scans.

The percentage of functionalization was determined by 1H NMR analysis carried out at 130° C. using deuterated tetrachloroethane (TCE-D2) as solvent and recorded in 5 mm tubes on a Varian Mercury spectrometer operating at a frequency of 400 MHz.

### Differential Scanning Calorimetry (DSC).

Melting (Tₘ) temperatures as well as enthalpies of the melting point (ΔH [J·g⁻¹]) of the transitions were measured using a Differential Scanning Calorimeter Q100 from TA Instruments. The measurements were carried out at a heating and cooling rate of 10° C.·min⁻¹ from −50° C. to 240° C. The transitions were deducted from the second heating and cooling curves.

The DSC has been used for the determination of the Crystallinity (X_{c}) content by comparing the enthalpies of melting transition of the sample with melting transition of the 100% crystalline polypropylene.

### Compression-Molding Experiments.

The film samples, used for the lap shear test, were prepared via compression-molding using PP ISO settings on LabEcon 600 high-temperature press (Fontijne Presses, the Netherlands). Namely, the films (25 mm×12.5 mm×0.5 mm) of functionalized polyolefins were loaded between the substrates: PP-PP, Steel-Steel, Aluminum-Aluminum or their combination with overlap surface 12.5 mm. Then, the compression-molding cycle was applied: heating to 130° C., stabilizing for 3 min with no force applied, 5 min with 100 kN (0.63 MPa) normal force and cooling down to 40° C. with 10° C.·min⁻¹ and 100 kN (0.63 MPa) normal force.

### Lap Shear Strength.

The measurements were performed with a Zwick type Z020 tensile tester equipped with a 10 kN load cell. Before measurements, samples were conditioned for 7 days at room temperature. The tests were performed on specimens (10 cm×2.5 cm) with surface overlapping 12.5 mm. A grip-to-grip separation of 140 mm was used. The samples were pre-stressed to 3 N, then loaded with a constant cross-head speed 100 mm min⁻¹. To calculate the lap shear strength the reported force value divided by the bonding surface (25 mm×12.5 mm) of the specimens. The reported values are an average of at least 5 measurements of each composition.

1. A hot melt adhesive comprising a polar group-containing olefin polymer comprising:
at least 80 mol % of a constituent unit represented by the following formula (1),
optionally a constituent unit represented by the following formula (2), and
between 0.1 to 1 mol %, of a constituent unit represented by the following formula (3): 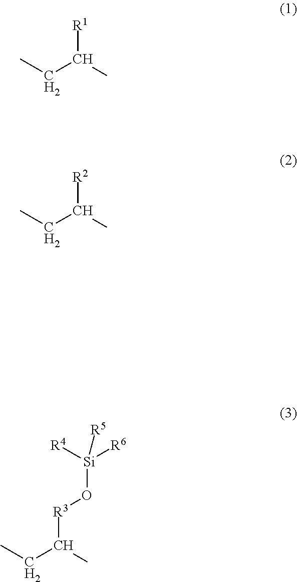
wherein:
R¹ is H or CH₃,
R² is selected from the list comprising: hydrocarbyl group having 0 to 10 carbon atoms,
R³ is either selected from the list comprising: hydrocarbyl group having 1 to 10 carbon atoms,
R4, R5, R6 can be identical or different and selected from the list comprising a hydrocarbyl group having 1 to 10 carbon atoms.

2. The hot melt adhesive according to claim 1, wherein polar group-containing olefin polymer is having at least one of the following:
Number average molecular weight (Mₙ) between 5 to 50 kg/mol,
Crystallinity (X_{c}) content below 30%,
Enthalpy (ΔH) between 5 to 65 J/g,
Polydispersity index (Ð) from 2 to 6,
Melting temperature (Tₘ) between 4° and 120° C.

3. The hot melt adhesive according to claim 1, wherein the constituent unit represented by the following formula (3) is the polymerization unit from one of the following monomers selected from the group comprising (allyloxy)trimethylsilane, (allyloxy)triethylsilane, (allyloxy)triisopropylsilane, tert-butyl(allyloxy)dimethylsilane, (allyloxy)dimethylphenylsilane, (but-3-en-1-yloxy)trimethylsilane, (but-3-en-1-yloxy)triethylsilane, (but-3-en-1-yloxy)triisopropylsilane, tert-butyl(but-3-en-1-yloxy)dimethylsilane, (but-3-en-1-yloxy)dimethylphenylsilane, (hex-5-en-1-yloxy)trimethylsilane, (hex-5-en-1-yloxy)triethylsilane, (hex-5-en-1-yloxy)triisopropylsilane, tert-butyl(hex-5-en-1-yloxy)dimethylsilane, (hex-5-en-1-yloxy)dimethylphenylsilane, trimethyl(undec-10-en-1-yloxy)silane, triethyl(undec-10-en-1-yloxy)silane, triisopropyl(undec-10-en-1-yloxy)silane.

4. The hot melt adhesive according to claim 1, wherein the polymerization of the polar group-containing olefin polymer has been performed using a solution process.

5. The hot melt adhesive to claim 1, wherein a siloxide-functionalized C₃ to C₁₂ monomer has been used during the polymerization.

6. The hot melt adhesive according to claim 1, wherein the hot melt adhesive resin is produced by treatment of a corresponding hydroxyl-functionalized co- or terpolymer with a silylation agent, wherein the hydroxyl-functionalized co- or terpolymer has been previously produced by the solution polymerization of one or more olefin monomer and a hydroxyl-functionalized olefin monomer, which was prior protected with an aluminum trialkyl.

7. The hot melt adhesive according to claim 1, wherein it is having at least one of the following binding properties, which have been measured by the method described in the section “Lap Shear Strength” of the Measurement methods section wherein the measurements were performed with a Zwick type Z020 tensile tester equipped with a 10 kN load cell. Before measurements, samples were conditioned for 7 days at room temperature. The tests were performed on specimens (10 cm×2.5 cm) with surface overlapping 12.5 mm. A grip-to-grip separation of 140 mm was used. The samples were pre-stressed to 3 N, then loaded with a constant cross-head speed 100 mm·min⁻¹. To calculate the lap shear strength the reported force value divided by the bonding surface (25 mm×12.5 mm) of the specimens; the reported values are an average of at least 5 measurements of each composition:
Steel to steel with a Lap Shear Strength above 3 MPa,
Aluminum to aluminum with a Lap Shear Strength above 3 MPa,
Steel to polyolefin with a Lap Shear Strength above 3 MPa,
Aluminum to polyolefin with a Lap Shear Strength above 1 MPa,
Polyolefin to polyolefin with a Lap Shear Strength above 3 MPa.

8. The hot melt adhesive according to claim 1, further comprising:
a. a polymer part, between 16-100 wt % of the hot melt adhesive,
b. a tackifier, between 0-70 wt % of the hot melt adhesive,
c. plasticizer, between 0-40 wt % of the hot melt adhesive,
d. a filler, between 0-10 wt % of the hot melt adhesive,
e. an antioxidant, between 0-3 wt % of the hot melt adhesive,
f. a pigment, between 0-1 wt % of the hot melt adhesive,
wherein the hot melt adhesive further comprises the polar group-containing olefin polymer, and the polar group-containing olefin polymer is at least a part of the polymer part, and the remaining part of the polymer part, if present, is another polymer.

9. A polar group-containing olefin polymer according to the following formula (4) 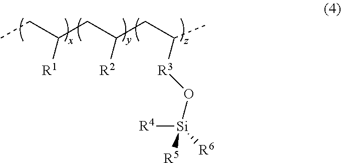
wherein
z is 0.1 to 1 mol %,
x is at least 80 mol %,
y is 0 or 100−(x+z) mol %,
R¹ is H or CH₃,
R² is selected from the list comprising: hydrocarbyl group having 0 to 10 carbon atoms,
R³ is a hydrocarbyl group having 1 to 10 carbon atoms,
R⁴, R⁵, R⁶ are identical or different and selected from the list comprising a hydrocarbyl group having 1 to 10 carbon atoms.

10. The polar group-containing olefin polymer according to claim 9, wherein the polymerization of the polar group-containing olefin polymer has been performed using a solution process.

11. A polar group-containing olefin polymer according to claim 9, wherein it is having at least one of the following:
Number average molecular weight (Mₙ) between 5 to 50 kg/mol,
Crystallinity (X_{c}) content below 30%,
Enthalpy (ΔH) between 5 to 65 J/g,
Polydispersity index (Ð) from 2 to 6,
Melting temperature (Tₘ) between 4° and 120° C.

12. A hot melt adhesive, photovoltaic encapsulants, bitumen binder, surface modifier for polyolefin, or compatibilizer comprising the polar group-containing olefin polymer according to claim 9.

13. A glue for gluing together metals, glass, stone, wood, polar polymers or metals to glass, metals to stone, metals to wood, metal to polar polymers, glass to stone, glass to wood, glass to polar polymers, stone to wood, stone to polar polymers, wood to polar polymers, metals to polyolefins, glass to polyolefins, stone to polyolefins, wood to polyolefins or polar polymers to polyolefins, the glue comprising the hot melt adhesive according to claim 1, wherein the stone comprises a mineral material.
